(19) United States
(12) Patent Application Publication
(10) Pub. No.: US 2015/0008339 A1
(43) Pub. Date: Jan. 8, 2015

(54) ANGULAR MULTIPLEXED OPTICAL PROJECTION TOMOGRAPHY

(71) Applicant: Imperial Innovations Limited, South Kensington (GB)

(72) Inventors: Paul Michael William French, West Sussex (GB); James Andrew McGinty, London (IE)

(21) Appl. No.: 14/383,323

(22) PCT Filed: Mar. 7, 2013
(86) PCT No.: PCT/GB2013/050568

§ 371 Date: Sep. 5, 2014

(30) Foreign Application Priority Data
Mar. 7, 2012 (GB) 1204004.4

(51) Int. Cl. G01N 21/64; G01N 21/47

(52) U.S. Cl. CPC G01N 21/6486; G01N 21/47; G01N 2201/06113; G01N 2201/08; G01N 2201/0697
USPC 250/458.1

(57) ABSTRACT

An optical projection tomography system comprises a support arranged to support an object (63) and to rotate the object between a plurality of orientations, a first imaging system (64) arranged to image the object from a first direction to form a first image, and a second imaging system arranged to image the object from a second direction to form a second image, data acquisition means (66, 67) arranged to acquire image data from the first and second images for each of the orientations and processing means arranged to process the image data to generate an image data set.

### FIELD OF THE INVENTION

The present invention relates to three-dimensional imaging systems, and in particular to optical projection tomography systems, for example for imaging mesoscopic biological samples.

### BACKGROUND TO THE INVENTION

As biological research progresses from studies of mono-layers of cells on glass to in situ measurements of both ex vivo and in vivo biological systems, it becomes necessary to apply three-dimensional (3-D) imaging techniques in order to map structure and function throughout a sample. Confocal/multiphoton/harmonic generation laser scanning microscopes provide optical sectioning to permit the acquisition of 3-D z-stacks (stacks of planar images) and also offer improved contrast compared to wide-field imaging but they suffer from limited (100's μm) penetration depth and fields of view (10's μm) and exhibit anisotropic resolution. Thus, while they are widely used to image microscopic specimens, they are less suitable for larger samples for which the acquisition of 3-D data sets can be very time consuming. To address this challenge, a number of imaging techniques have been developed for samples in the “mesoscopic” regime (1-10 mm), including optical projection tomography (OPT), selective plane illumination microscopy (SPIM) and ultramicroscopy. Of these, OPT is particularly suitable for studying larger (>1 mm) samples.

OPT is the optical equivalent of X-ray computed tomography (CT), in which the 3-D structure (a stack of X-Z slices) of a rotating sample is reconstructed from a series of wide-field 2-D projections (X-Y images) obtained at different projection angles. Typically, digital images are acquired throughout a full rotation (360°) and a filtered back-projection (FBP) algorithm is used for image reconstruction. This approach assumes parallel projection corresponding to parallel ray (or plane wave) propagation of the signal with negligible scattering in the sample. This is appropriate for X-ray CT, but optical scattering can be a significant issue when imaging in biological tissue.

Reconstructed OPT images can suffer from a scattered light background unless the samples are inherently transparent or have been rendered transparent by a chemical clearing process.

OPT has been widely applied to anatomical studies of fixed, cleared samples such as mouse embryos for research into developmental biology. However it would potentially be beneficial to apply it to histopathology and the study of disease mechanisms and potential therapies in disease models. OPT images can be formed using transmitted light, e.g. to map absorption coefficients, or using fluorescence radiation. FIG. 1 shows a transmission OPT system in which an optical light source 10 is located on one side of a sample chamber 12 and arranged to direct light towards the chamber 12, and a detector array, such as a CCD detector array 14 is located on the opposite side of the chamber to the source 10 and arranged to detect light from the source that is transmitted through the sample chamber 12 and through the sample 13 located in the chamber. FIG. 2 shows a fluorescence OPT system in which the source 20 is located on one side of the sample chamber 22 and a detector array such as a CCD array 24 is located away from the axis along which light is emitted from the source, and arranged to detect light emitted by fluorescence from the sample chamber 22. In each case the chamber 12, 22 includes a rotating sample holder which can be rotated so as to rotate the sample 13, 23 between a number of orientations to allow plane images to be formed for each of a number of projections. The transmitted light or fluorescence radiation can be characterised to provide spectroscopic information, e.g. spectrally resolving the light or resolving fluorescence radiation with respect to excitation and emission spectra, fluorescence lifetime and/or polarisation. One possible application is to utilise fluorescence lifetime imaging (FLIM) to provide a spectroscopic readout for OPT.

For histopathology, OPT offers the opportunity to directly obtain 3-D images of intact “volumetric” samples rather than the standard approach of mechanically slicing the samples and combining digital images of each section to reconstruct 3-D images. This is important because mechanical “sectioning” can damage fragile samples.

Absorption contrast can arise from endogenous chromophores, including blood, and from exogenous labels or stains, e.g. the standard H&E stain. Fluorescence contrast can arise from endogenous fluorophores, such as elastin, collagen, NADH, flavoproteins etc, or from exogenous labels including dyes or genetically expressed fluorescent proteins—although the fluorescence properties of the latter can be degraded by the chemical clearing process. The autofluorescence can sometimes be used, e.g. by using spectroscopic parameters such as fluorescence lifetime, to provide a label-free readout of the state of biological tissue, e.g. to indicate disease or damage, or to contrast different types of tissue.

For studying disease and for drug discovery, there is an increasing interest in translating studies of biological processes at the cellular level from monolayers (or very thin layers a few cells thick) of cell cultures on coverslips to 3-D cell or tissue cultures or to live organisms. The chemical clearing process is inherently fatal to live organisms and so it is interesting to apply OPT and other optical imaging techniques to inherently transparent live organisms—particularly those that can be genetically manipulated to serve as disease models. To date OPT has been applied to D. melanogaster [C. Vinegoni, C. Pitsouli, D. Razansky, N. Perrimon, V. Ntziachristos, “In vivo imaging of Drosophila melanogaster pupae with mesoscopic fluorescence tomography ,” Nat. Meth. 5, 45-47 (2008)] , C. elegans [U. J. Birk, M. Rieckher, N. Konstantinides, A. Darrell, A. Sarasa-Renedo, H. Meyer, N. Tavernarakis, J. Ripoll, “Correction for specimen movement and rotation errors for in-vivo optical projection tomography,” Biomed. Opt. Exp. 1, 87-96 (2010] and Danio rerio (zebrafish) embryos [J. McGinty, H. B. Taylor, L. Chen, L. Bugeon, J. R. Lamb, M. J. Dallman, P. M. W. French, “In vivo fluorescence lifetime optical projection tomography,” Biomed. Opt. Express 2, 1340-1350 (2011)]. As well as imaging the spatial- temporal distribution of fluorescent labels (e.g. fluorescent proteins that are labeling specific proteins of interest), it is also possible to study the interactions of biomolecules and this can be done using Förster resonant energy transfer (FRET), which can be read out using FLIM [S. Kumar et al. FLIM FRET Technology for Drug Discovery: Automated Multiwell-Plate High-Content Analysis, Multiplexed Readouts and Application in Situ. Chemphyschem 12: 609-626 (2011)].

The potential to apply OPT to “mesoscopic” samples (i.e. mm-cm scale) for biomedical research has prompted significant interest in optimizing the image quality and resolution and minimizing the image data acquisition time. Image quality can be degraded by artifacts resulting from system misalignment, intensity-based signal variations and system aberrations and methods have been described to correct or suppress such artifacts. Two fundamental limits that can restrict the application of OPT are imaging speed and spatial resolution. As has been established with x-ray computed tomography, a minimum number of angular projections are required to adequately sample the subject and provide a reasonable tomographic reconstruction. For OPT of mm-cm samples, this is in some cases approximately 360 projections (i.e. angularly spaced by one degree), which implies a total image acquisition time of 360 ×the time for a single image acquisition, which can vary from ms to seconds. The image acquisition time is particularly extended for FLIM OPT where a series of time-gated fluorescence intensity images are acquired at each angular projection as shown in FIG. 3. In such a system a light source in the form of a laser 30 is arranged to direct pulses of light towards a sample chamber 32, in this case via a mirror 34. A detector array in the form of a CCD array 36 is arranged to detect fluorescent light emissions from a sample 33 supported on a rotatable holder within the sample chamber 32. A gated optical intensifier (GOI) 38 is arranged between the chamber 32 and the detector array 36 and a filter 39 is located between the chamber 32 and the GOI. The GOI is arranged to expose the detector array 36 to the fluorescent light only during short imaging periods. A delay generator 40, controlled by a computer 42, is arranged to control the light source 30 to generate a series of laser pulses. After each laser pulse, the delay generator 40 is arranged to operate the GOI to define a series of imaging periods. For each of the imaging periods the computer 42, which is connected to the output of the CCD array 36, is arranged to store a set of image data. Therefore, for each laser pulse, a series of image data sets is built up corresponding to the fluorescent light emitted at different times after the laser pulse. This data can be use to generate FLIM OPT images as is well known.

It is possible to reduce image acquisition time for a FLIM OPT system by reducing the number of angular projections and compromising image quality but the distortion becomes significant for less than about 90 projections. In general it is desirable to minimize the image acquisition time for experimental convenience, to be able to resolve dynamics and to minimize the exposure of the sample to optical radiation, which can result in photobleaching of fluorophores and phototoxicity.

Image quality can also be degraded by deviations from the parallel ray assumption that underlies the standard FBP algorithm. These arise when OPT is implemented with a relatively high numerical aperture (NA) optics, for which rays at a relatively large range of angles with respect to the optical axis are collected. FIG. 4 shows the relationship between the depth of field (DOF) and the numerical aperture NA, in particular a high NA results in a low DOF. High NA optics are necessary for producing magnified images of small samples and are generally desirable for fluorescence imaging because the light collection efficiency increases with numerical aperture. There is a trade-off between increasing the NA to improve the in-focus lateral resolution and reducing the NA to increase the depth of field (DOF) in order to ensure that the whole sample is in reasonable focus (i.e. that the lateral resolution does not vary significantly along the optical axis). FIG. 4 shows the limiting case (sketched for a single resolution element) when the depth of field of the imaging system is comparable to the diameter of the sample. In this case the tomographic image is reconstructed from plane wavefronts as expected for back projection.

When OPT is undertaken with samples that extend beyond the confocal parameter (Rayleigh range) of the imaging lens—as is often the case—the tangential resolution of the reconstructed images typically decreases radially away from the axis of rotation. FIG. 5(a) however shows the case when the DOF is matched to the radius of the sample—in this case all of the sample will be “in focus” for part of its revolution and an image of approximately uniform spatial resolution can still be reconstructed.

For the case illustrated in FIG. 5(b), however, the DOF is less than the sample radius and the reconstructed spatial resolution will be decreased (and the image degraded) away from the focal plane. This situation is typical for many biomedical applications where high resolution (from high NA optics) is required but the sample size (e.g. a zebrafish embryo) is much greater than the DOF. For imaging zebrafish in an OPT microscope with a NA of ˜0.07, which corresponds to a depth of field of ˜400λ, (˜200 μm for a wavelength of 500 nm) the spatial resolution in the focal plane is ˜4.4 μm but this is degraded away from the optical axis. Since a zebrafish embryo is typically ˜1 mm in diameter, the spatial resolution therefore varies significantly across the sample.

One way to address this issue and achieve a uniform illumination throughout a sample that is large than the DOF of the imaging system is to translate the sample with respect to the focal plane such that different portions of the sample are sequentially imaged “in focus”. Unfortunately this adds significantly to the total image acquisition time and increases the total light exposure for each tomographic image acquisition. It also adds expense and complexity because of the additional moving parts compared to the single axis rotation of OPT.

### SUMMARY OF THE INVENTION

The present invention provides a tomography system, which may be an optical projection tomography system, comprising a support arranged to support an object and to rotate the object, a first imaging system arranged to image the object from a first direction and a second, or further, imaging system arranged to image the object from a second, or further, direction.

The support may be arranged to rotate the object about an axis, and the first and second, or further, directions may be angularly spaced around the axis.

The system may further comprise data acquisition means arranged to acquire a plurality of sets of image data from each of the imaging systems. The support means may be arranged to rotate the object between a plurality of orientations and the data acquisition means may be arranged to acquire at least one data set, or one data set from each imaging system, for each of the orientations. The data acquisition means may be arranged to acquire a data set from each of the imaging systems simultaneously, or in succession, for each of the orientations. The angular offset or spacing between the imaging systems about the axis may be an integer multiple of the angular spacing between the orientations, so that as the object is rotated both of the imaging systems can be used to generate image data sets from the same direction relative to the object. Alternatively the angular offset or spacing between the imaging systems about the axis may be an integer multiple of the angular spacing between the orientations plus a fraction, such as a half, of that angular spacing, so that as the object is rotated both of the imaging systems can be used to generate image data sets from directions which are angularly spaced relative to the object more closely than, for example at half of, the angular spacing between the object orientations.

In some embodiments more than two imaging systems could be used, for example three or four, or more.

The imaging systems can be focussed at respective focal points or planes which are equidistant from the axis of rotation of the object. However, the focal points or planes may be at different distances from the axis of rotation. This means that as the object is rotated, different parts of it will be imaged in focus by the two (or more) imaging systems.

Each of the imaging systems may comprise a respective optical system and a respective image capture device, such as a CCD camera. Alternatively a single image capture device may be arranged to capture images from both (or all) of the optical systems. For example a single image capture device may comprise an array of elements, typically a rectangular array, and two halves of the array may be used for the respective images.

The light may be directed onto the array by various methods. For example the optical systems may each comprise one or more mirrors to achieve this, or they may each comprise one or more bundles of optical fibres. The optical fibre bundles will have one end arranged to receive light from the object and one end from which the light will be emitted towards the image capture device. In a simple arrangement the shape of the bundle is the same at both ends, and the relative positions of each of the fibres in the bundle are the same at both ends. However in some embodiments the relative positions of the fibres in the bundle is different at one end from the other. For example the cross section of the bundle may be a different shape, for example having a different aspect ratio, at its two ends.

The system may further comprise processing means, such as a processor, arranged to receive the image data sets and process them to generate a further image data set, which may be a tomographic or three-dimensional image data set. Where the imaging systems are focused on different parts of the object, the processing means may be arranged to combine the data sets and the further image data set may be suitable to generate an image of both of the different parts of the object. Where optical fibre bundles are used with fibre positions that are different at the two ends of the bundle, the processing means may be arranged to compensate for that difference when generating the further image data set.

The processing means may be arrange to identify a feature in the 3D tomographic image, and then at each of a series of subsequent times, determine the location of that feature from two (or more) projection images acquired using the two (or more) optical systems. The series of subsequent projection images may be acquired with the sample stationary.

The system may be an optical projection tomography system, and for example may be a fluorescent imaging system. However it may be transmission imaging system, or even a scattering imaging system. In each case the system may further comprise a source of radiation which may be detected after transmission through, or scattering in, the object, or which may cause the fluorescence which is then detected.

An advantage of some embodiments of the invention is that they can ameliorate the trade-off between spatial resolution and depth of field for relatively high NA OPT systems with extended samples while simultaneously reducing the total image acquisition time and the corresponding light dose. This may be achieved by angular multiplexing, i.e. by acquiring image data at multiple projection angles simultaneously. As well as addressing the issue of spatial resolution, this approach may also reduce the image acquisition time. Furthermore, it may be extended to provide feature tracking with a time resolution comparable to the time for one angular projection acquisition rather than the total tomographic image acquisition time.

The system may further comprise a sample chamber. The support means may be arranged to support the sample within the chamber. The chamber may have a wall part of which may be formed by a lens which also forms part of one of the optical systems. Indeed each of the optical systems may include a lens which forms part of the wall of the chamber.

The chamber may be filled with an index matching fluid having a refractive index similar to that of the sample.

The system may further comprise a transparent cylinder within the chamber. The chamber may be filled with index matching fluid both inside and outside the cylinder. The cylinder may be arranged to rotate inside the chamber, together with the sample.

Some embodiments of the invention may permit the use of multiple simultaneous imaging directions by arranging for the sample to be rotated in a chamber where the imaging lenses (objective lenses) are integrated into the walls of the chamber.

Some embodiments of the invention may permit the use of multiple simultaneous imaging directions using imaging (objective) lenses to be more closely spaced and/or of shorter working distance that would be possible using conventional objective lenses.

Some embodiments of the invention may permit the use of multiple simultaneous imaging directions using imaging (objective) lenses integrated into the walls of the chamber such that their focal planes are at the same distance or at different distances from the axis of rotation.

Some embodiments of the invention may permit the use of multiple simultaneous imaging directions using imaging (objective) lenses integrated into the walls of the chamber where the chamber is filled with index matching fluid of similar refractive index to the sample.

Some embodiments of the invention may permit the use of multiple simultaneous imaging directions using imaging (objective) lenses integrated into the walls of the chamber where the sample is located in a transparent rotating cylinder within the chamber and where the cylinder and the chamber are filled with index matching fluid of similar refractive index to the sample.

Some embodiments of the invention may permit the use of multiple simultaneous imaging directions by arranging for the sample to be imaged with multiple imaging lenses (objective lenses) with the resulting images being relayed to one or more imaging detectors that each record the images from two or more imaging directions. The system may further comprise any one or more features, in any combination, of the embodiments of the invention that will now be described by way of example only with reference to the accompanying drawings.

### BRIEF DESCRIPTION OF THE DRAWINGS

FIG. 1 is a schematic view of a transmission OPT system forming part of an embodiment of the invention;

FIG. 2 is a schematic view of a fluorescence OPT system forming part of an embodiment of the invention;

FIG. 3 is a schematic view of a fluorescent lifetime imaging system forming part of an embodiment of the invention;

FIG. 4 is a diagram showing the depth of view and numerical aperture in an OPT system;

FIGS. 5a and 5b are diagrams of different sized samples in an OPT system;

FIG. 6 is a diagram of an OPT system according to an embodiment of the invention;

FIG. 7 is a diagram of an OPT system according to a further embodiment of the invention;

FIG. 8 is a diagram of an OPT system according to a further embodiment of the invention;

FIG. 9 is a diagram of an OPT system according to a further embodiment of the invention;

FIG. 10 is a diagram of an OPT system according to a further embodiment of the invention;

FIG. 11 is a diagram of an OPT system according to a further embodiment of the invention;

FIGS. 12a and 12b are sections through OPT systems according to further embodiments of the invention; and

FIG. 13 is a schematic view of an OPT system according to a further embodiment of the invention.

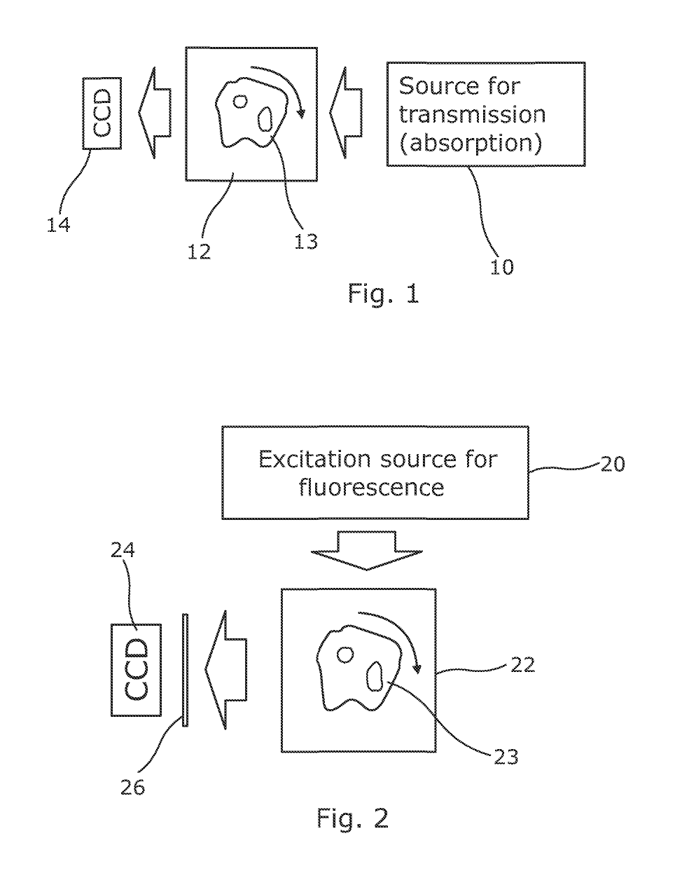

### DESCRIPTION OF EMBODIMENTS OF THE INVENTION

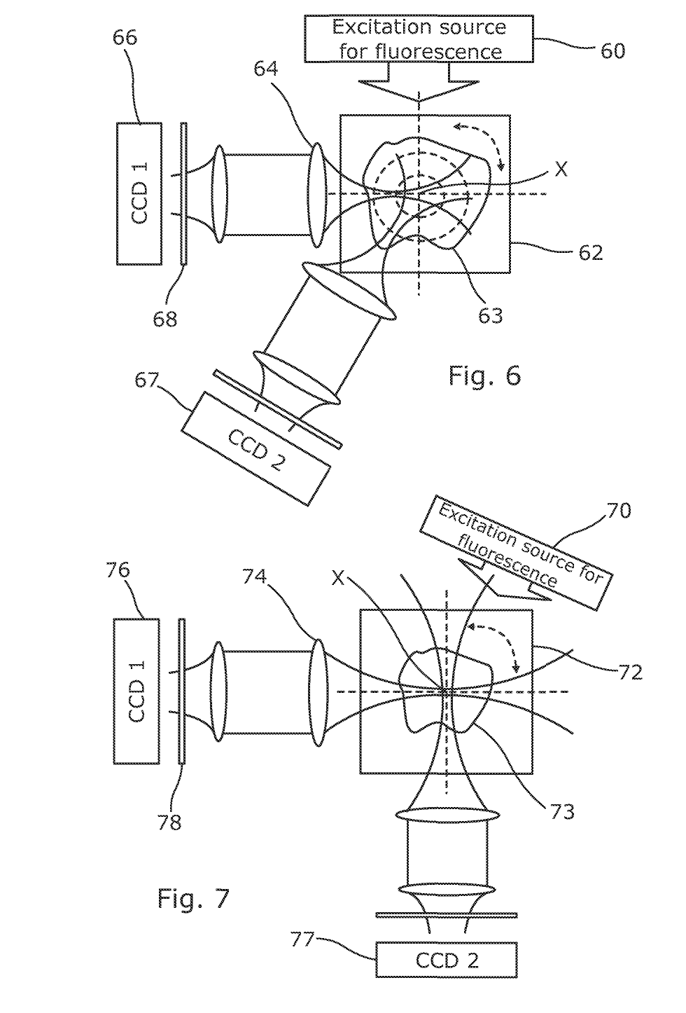

Referring to FIG. 6 an imaging system according to an embodiment of the invention comprises a single light source 60 and a sample chamber 62 having a rotatable sample holder for supporting a sample 63 and arranged to rotate the sample about an axis of rotation X. Two detector arrays 66, 67 are each arranged to detect fluorescent emissions from the sample 63 and are offset from the transmission direction of the source 60 by different amounts, in this case 45° and 90°.

Each of the detector arrays 66, 67 has its own optical system, in each case comprising lenses 64 and a filter 68. In this embodiment each of the CCD arrays 66, 67 faces in the direction from which light will be emitted from the sample 63 to reach the it, so the two detector arrays are arranged to generate image data for projection angles that are separated by 45°. This angular separation can be selected as desired by altering the position of one of the CCD arrays with its optical system, or by modifying one or both of the optical systems so that it collects light emitted from the sample in a different direction.

Each of the optical systems has a focus which is spaced from the axis of rotation X of the sample. In this embodiment, the focal points of the two optical systems are different distances from the axis X. This means that one of the imaging systems is focussed on a part of the sample that is closer to the axis X than the other imaging system. Therefore as the sample is rotated, the detector arrange 66 generates images of the region of the sample close to the axis X, and the detector array 67 generates images of the region of the sample further from the axis X. These can therefore be combined to form an “in focus” image of the complete sample. 2. As multiple regions of the sample are imaged “in focus” simultaneously, this permits higher NA optics to be used with a given sample, thereby increasing the achievable spatial resolution and the light collection efficiency while maintaining a reasonably uniform resolution throughout the sample.

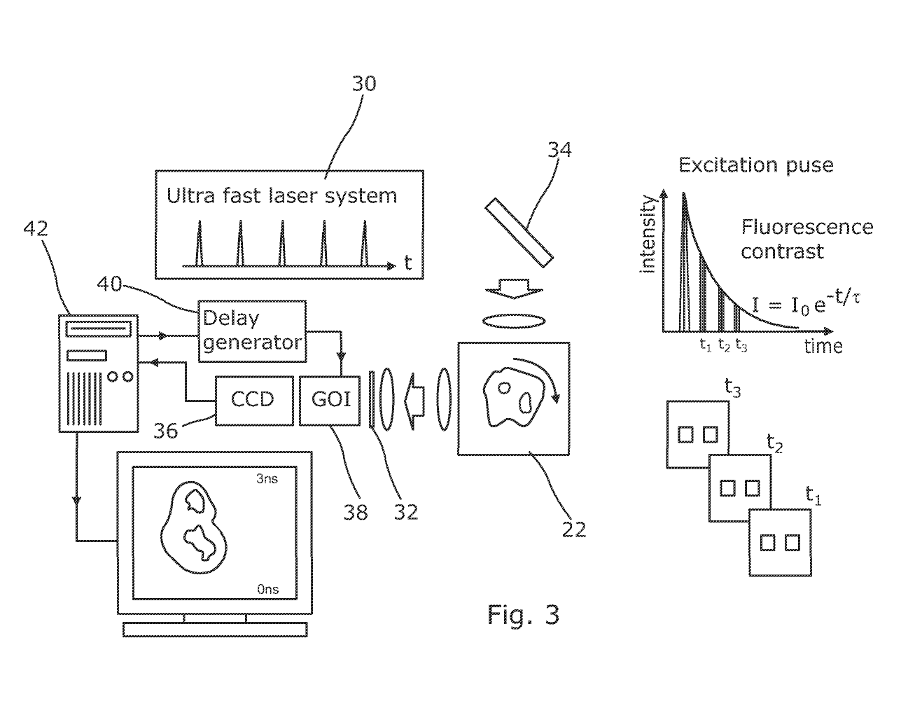

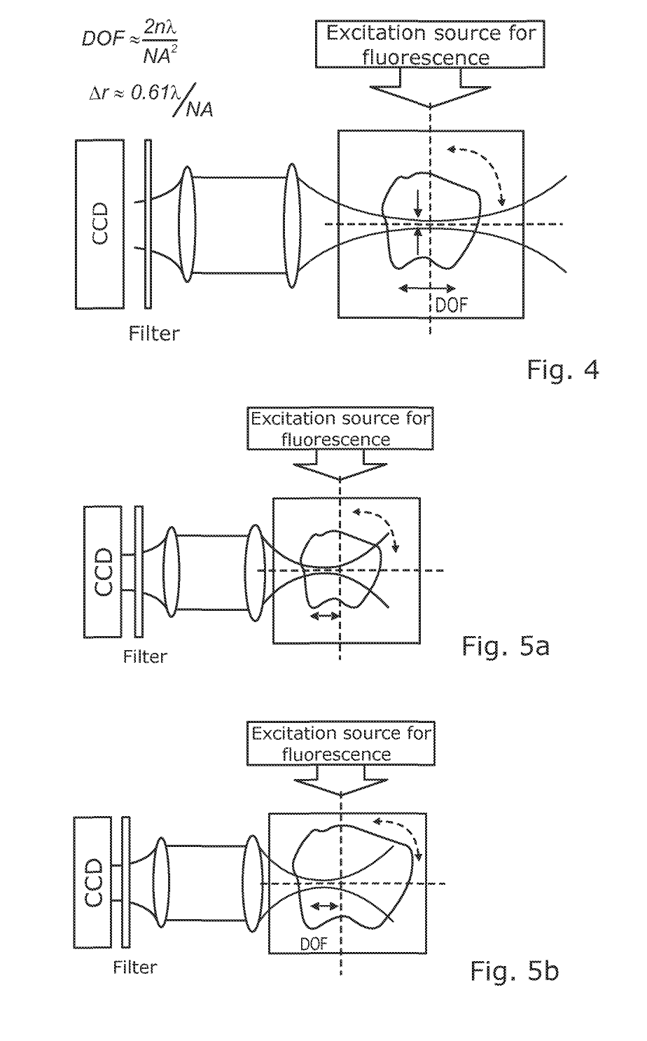

Each of the imaging systems may be a simple fluorescent imaging system as shown in FIG. 2, or a FLIM system as shown in FIG. 3. One or more computers, not shown, can be arranged to control the rotation of the sample, the operation of the light source, and the collection of image data for each projection angle, and the generation of the final 3D image.

Referring to FIG. 7, in a system according to a further embodiment of the invention, the setup is similar to that of FIG. 6, with corresponding components indicated by the same numbers but increased by 10. However in this case, both of the optical systems are focussed on the axis of rotation X of the sample. Therefore the two detector arrays 76, 77 are arranged to image the sample 73 at the same depth. This means that the same number of projections can be imaged as with the single imaging system using half the number of rotational positions of the sample.

It will be appreciated that in both of the systems of FIG. 6 and FIG. 7, the use of two image acquisition systems acquiring image data simultaneously at different angular projections addresses the issue of imaging speed by reducing the time to acquire a tomographic image (for a given number of detected photons) and therefore also reduces the total light dose received by the sample. In other embodiments three or more image acquisition systems are used, again spaced around the sample so as to capture images simultaneously at different projection angles, thereby further increasing the efficiency of image acquisition.

With multiple angularly separated image acquisition systems, as in the system of FIG. 7, it is possible to under-sample the projection angles with each imaging system and combine the data computationally to recover tomographic images with superior image quality to what would be obtained with the data from a single one of the imaging systems. With the system of FIG. 6 this is because the two multiplexed data sets will overlap, even though they are focussed at different depths. With the system of FIG. 7 it is because the two data sets are acquired at interleaved sets of angular projections.

In a further embodiment which is a modification of the system of FIG. 7, the basic image acquisition is the same as in the system of FIG. 7, but the computer which processes the data from the detector arrays is arranged, at each rotational position of the sample, to locate a feature of the sample in three dimensions. To achieve this the computer is arranged to identify a feature in the projection image from both of the CCD arrays, determine its position in two dimensions from each of the projection images, and then from the known spatial relationship between the two imaging systems, determine the location of the feature in three dimensions, for example using orthogonal projections as illustrated in FIG. 7. Thus motion of the feature, such as a cell, a group of cells, or an organ or other part of a biological sample, can be tracked with a time resolution of the individual acquisition systems rather than the total acquisition time for the full tomographic data set incorporating all angular projections. The motion can either simply be measured and recorded, by determining the position of the feature each time it is imaged, or can be used to generate an enhanced image sequence in which a detailed 3D image of the feature and the surrounding parts of the sample is built up from a full set of projection images, and then a new image is formed after each rotational position of the sample by shifting the 3D image of the feature within the whole 3D image by a distance corresponding to the detected movement of the feature between successive projection image acquisition times.

In a modification to this process, a 3D image can be generated from a full set of projection images, by rotating the sample, and then the sample can be left stationary and sets of projection images acquired, each set comprising a projection image from each of the optical systems. Each of these subsequent sets of projection images can then be used to locate the feature, so that movement of the feature can be tracked as described above, but with the sample stationary. This can enable, for example, rapid cell migration to be mapped within a zebrafish. This can be implemented with the multiplexed imaging systems imaged focussed to the same depth as in FIG. 7, or to different depths as in the system of FIG. 6.

As well as determining the location of a feature at the projection image collection rate (frequency), other parameters of the image can be collected at that rate as well. For example spectroscopic parameters such as emission wavelength or fluorescence lifetime can also be read out at the frame rate of individual image acquisitions rather than the total frame rate. This is also possible using just one image recording system but multiple simultaneous angular projections improve the localisation of the spectroscopic features. This allows the spectroscopic data to be associated accurately with a particular feature of the 3D image, and changes in the spectroscopic data for a feature to be monitored with a sample rate equal to the projection image acquisition rate. This data can then be analysed offline, or used to update an image of the sample as it is displayed in real time.

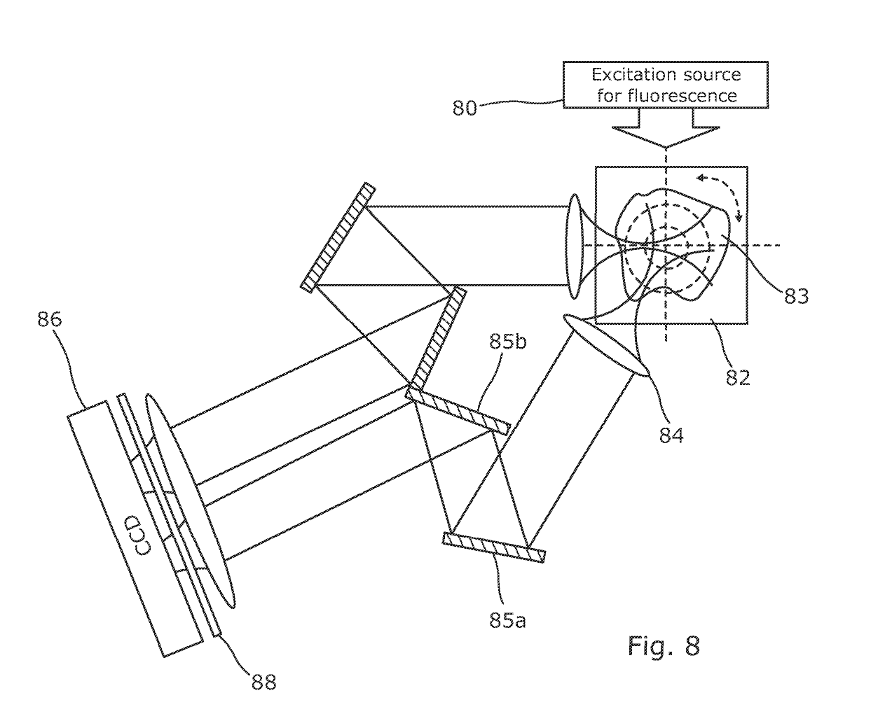

In the embodiments of FIGS. 6 and 7 the multiplexed OPT system has multiple imaging systems, each with a separate CCD camera (or other image capture device such as a CMOS camera or a FLIM system). Referring to FIG. 8, in a further embodiment simultaneous imaging at multiple angular projections is achieved by relaying the multiple simultaneous images to a single CCD camera or other image capture device. Specifically there is still one light source 80 and a sample chamber 82 containing the sample 83, and two optical systems each comprising an objective lens 84, with the two objective lenses being arranged to collect light from the sample in respective different directions. However a pair of mirrors 85a, 85b is arranged to direct light from one of the objective lenses 84 onto one part of the CCD array 86, and a similar pair of mirrors is arranged to direct light from the other objective lens onto a different part of the CCD array. The computer or other processing system arranged to process the image data generated by the CCD array is arranged to process and store the data from each half of the CCD array separately as a separate projection image. As with the embodiments of FIGS. 6 and 7, two projection images can be collected for each orientation of the sample. This arrangement can provide a lower cost implementation than using two separate imaging systems with distinct cameras. This approach could be used with two or more imaging systems focussed to different depths in the sample as in the embodiment of FIG. 6, or to multiple imaging systems focussed to the same depth to provide rapid feature tracking etc. as in the embodiment of FIG. 7. Other optical configurations could be used to combine multiple simultaneous imaging systems at different angular projections to a single image capture device.

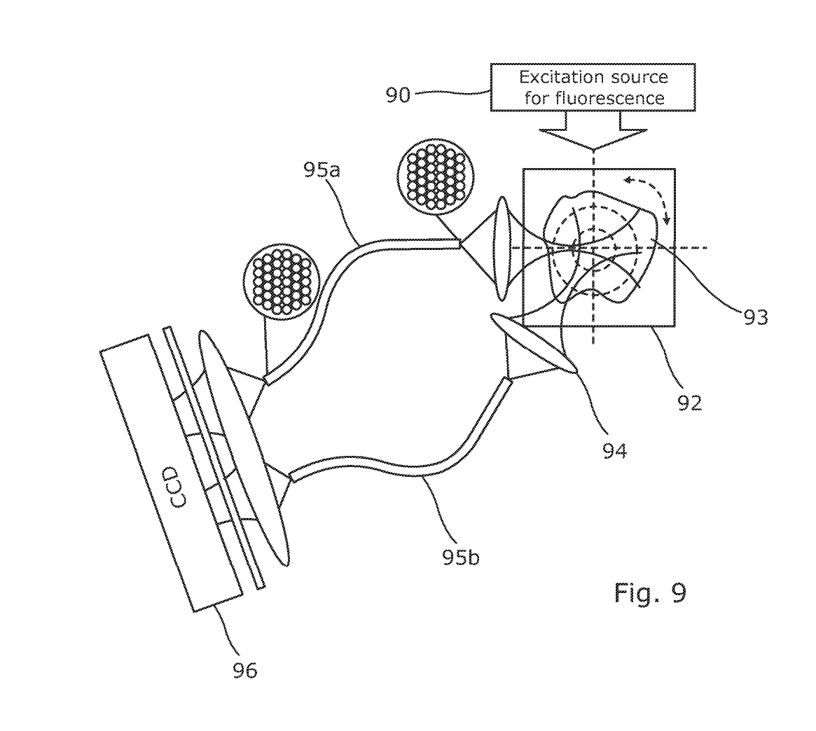

FIG. 9 shows a further embodiment similar to that of FIG. 8 but using optical fibre imaging bundles. In FIG. 9 features corresponding to those in FIG. 8 are indicated by the same reference numeral increased by 10. The main difference is that, instead of mirrors being used to direct the light from the objective lenses towards the detector array, two fibre optic bundles 95a, 95b are provided each having one end located so that it receives light from a respective one of the objective lenses 94 and the other end arranged to direct light towards part of the CCD array 96.

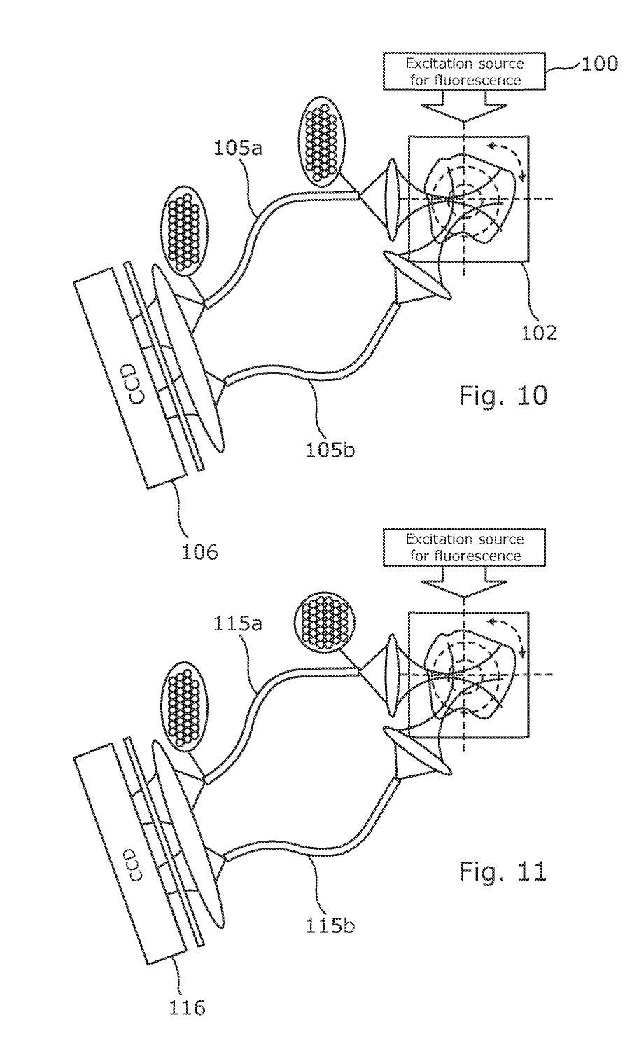

Referring to FIG. 10, in a modification to the embodiment of FIG. 9, the fibre optic bundles are of an approximately rectangular cross section, being approximately twice as wide in one direction than they are in the perpendicular direction. The advantage of this is that, for a substantially square CCD array 106, the array can be divided into two rectangular halves each arranged to receive light from one of the fibre optic bundles. This allows the bundles to be of constant shape in cross section along their length, whilst utilising the full area of the CCD array to capture the two images. This is effective provided a rectangular field of view is acceptable. Alternatively the objective lens or an additional lens system can be arranged to project an image of a substantially square field of view onto the rectangular end of the fibre optic bundle. This simply requires a rotationally non-symmetrical lens to compress the image in one direction. This allows a set of substantially square (or circular) images to be captured with the system of FIG. 10.

In the embodiments of FIGS. 9 and 10, the relative positions of the optic fibres in each of the bundles is constant along the length of the bundle, so the image collected by the CCD array 96, 106 is the same as if the fibre optic bundle were not present. Processing of the images is therefore the same as in the embodiment of FIG. 6 or FIG. 7. However, referring to FIG. 11, in a further embodiment each of the fibre optic bundles is approximately square at the end that receives light from the sample, and approximately rectangular at the other end from which light is emitted towards the detector array 116. Geometrically this has the advantage that the area imaged is substantially square, but that two images can be captured on rectangular areas of a substantially square CCD array 116. For this system to function, the computer or other processor that processes the signals from the CCD array 116 needs to compensate for the difference in relative positions of the fibres at one end of the fibre optic bundle and the relative positions at the other end. Provided the change in relative position of each of the fibres between the two ends of the bundle is known, the processor can be arranged to correct for that change, so that the image as collected by the CCD array can be converted back to the form in which it was received by the fibre optic bundle from the objective lens. This can be achieved, for example, by defining a mapping between the position of each of the fibre ends at the ‘output’ end of the bundle and a position in the image. This mapping obviously corresponds to the mapping between the position of each of the fibre ends at the ‘output’ end of the bundle and the positions of the same fibre end at the ‘input’ end of the bundle. The processor is therefore arranged to generate, for each orientation of the object, two projection images, one from each of the directions in which the two objective lenses are facing.

Whilst conceptually any change of shape between the two ends of the fibre optic bundle could be corrected in this way, and indeed a complete re-arranging of the fibres along the length of the bundle could be corrected, in practice it is simpler if the changes in relative positions of the individual fibres is kept to a minimum for any required change of shape of the bundle.

Another possible implementation is to change the aspect ratio of the imaging systems between the imaging objective and the image capture device, in a way similar to that of FIG. 11, but using free space optics rather than the fibre optic bundles.

As well as CCD cameras, the images can be recorded on any other type of 2-D image capture device such as a CMOS camera (including the recently available sCMOS that can provide high speed imaging with more pixels than most CCD cameras). Image capture devices with large numbers of pixels are advantageous for implementations where multiple simultaneous angular projections are to be to be captured on a single imaging sensor. It is also beneficial to use image sensors with appropriate aspect ratios, for example rectangular, to accommodate multiple images in parallel.

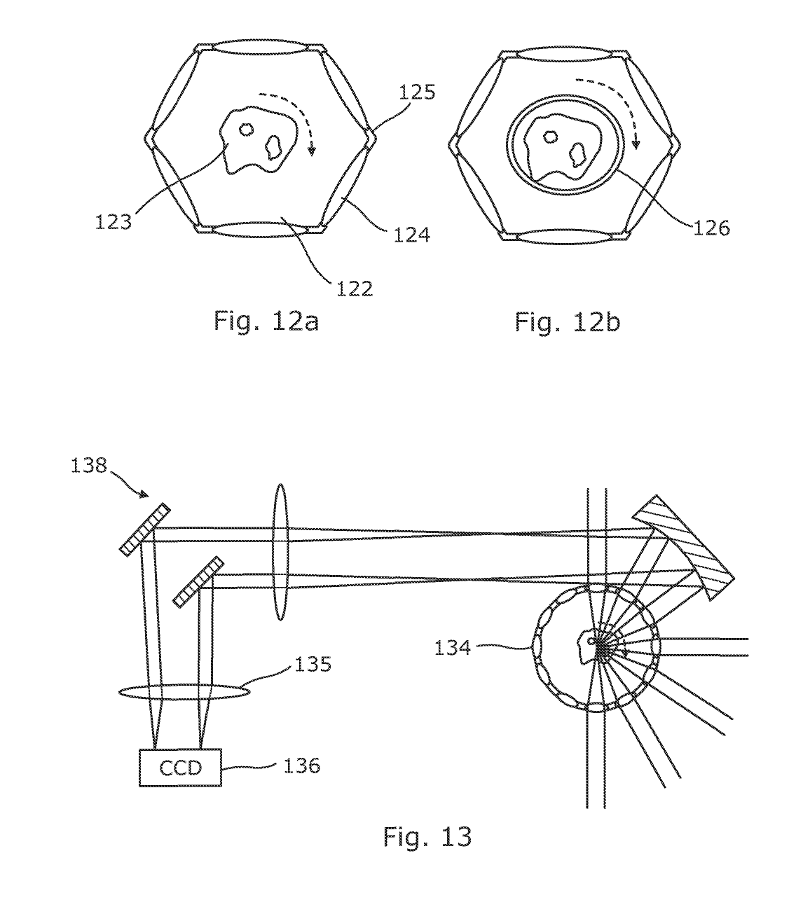

Referring to FIG. 12a, to implement multiplexed OPT with more than two simultaneous projection angles is also possible using multiple imaging systems each with their own image capture device, i.e. corresponding to the embodiment of FIG. 6 or FIG. 7 but with more than two CCD cameras. This approach is limited by the finite size of the lenses and their working distances as the concept is extended to more imaging channels. The arrangement of FIG. 12a includes multiple lenses arranged close to the sample permitting imaging with relatively high numerical apertures and low working distances. The system includes a hexagonal chamber 122 that can be filled with index matching fluid of similar refractive index to the sample 123. The chamber 122 has six lenses 124 inset in, and therefore forming part of, the walls of the chamber. A liquid-tight seal 125 surrounds each lens and seals it to the adjacent parts of the chamber wall, which can be another lens or part of a support structure which forms the rest of the wall and supports the lenses. The lenses (which serve as the objective lenses of the parallel imaging systems) can be positioned at different distances from the axis of rotation so that they are focussed to different depths in the sample, or at the same distance as shown in FIG. 12. This can be done by making the lens position mechanically adjustable or by engineering the lens mountings in the chamber to locate each lens at the desired distance from the axis of rotation.

The sample 123 can be mounted or suspended in the centre of the chamber 122 as shown in FIG. 12a and rotated or it can be mounted in a transparent cylinder 126, or other shaped container, of similar refractive index to the index matching liquid in the chamber as shown in FIG. 12b. The cylinder 126 would also be filled with the index matching liquid. In some configurations, the sample is fixed relative to the cylinder and the cylinder would be rotated to acquire the OPT data set. The sample may be illuminated through one or more of the lenses to provide absorption contrast for the OPT reconstructions or, for fluorescence imaging, the illumination may be introduced from above or below or via a small aperture (e.g. using an optical fibre) between two of the lenses. The excitation light source should ideally be sufficiently divergent to illuminate the whole sample. For some applications it is convenient to use more than one illumination source (for absorption or fluorescence contrast). This concept can be extended to chambers having a different number of sides with a different number of lenses—three or more sides with a corresponding number of imaging channels can be used.

Referring to FIG. 13, it can be convenient to combine the outputs of multiple imaging channels onto a smaller number of image capture devices 136. For the situation where a large number of imaging channels are used, in this case 12 are shown, it is possible to use a large imaging system 138 (or set of such systems) to relay the outputs from multiple objective lenses 134 onto a smaller number of tube lenses 135 and image capture devices 136. In FIG. 13 only one image capture device is shown with the outputs of two imaging channels being relayed onto the single image capture device. Obviously this is extended to relay the outputs of all 12 of the imaging channels to six image capture devices.

The present invention can be applied to any current application of OPT including developmental biology of both animals and plants, volumetric histopathology of ex vivo samples, in vivo imaging of live disease models such as zebrafish for drug discovery and studies of disease mechanisms. For imaging live samples, it is extremely important to minimise the image acquisition time and the light dose in order to maximise the survival chances of the samples and to minimise the time they are maintained anaesthetized. Some embodiments of the present invention can address this critical issue by reducing the image acquisition time to acquire high resolution images and increasing the light collection efficiency by enabling the use of higher NA imaging systems.

1. An optical projection tomography system comprising a support arranged to support an object and to rotate the object between a plurality of orientations, a first imaging system arranged to image the object from a first direction to form a first image, and a second imaging system arranged to image the object from a second direction to form a second image, a data acquisition system arranged to acquire image data from the first and second images for each of the orientations and a processor arranged to process the image data to generate an image data set.

2. A system according to claim 1 wherein the support means is arranged to rotate the object about an axis, and the first and second directions are angularly spaced around the axis.

3. A system according to claim 1 wherein the data acquisition system is arranged to acquire a data set from each of the imaging systems simultaneously.

4. A system according to clam 1 wherein the angular spacing between the imaging systems is an integer multiple of the angular spacing between the orientations.

5. A system according to clam 1 wherein the angular spacing between the imaging systems is an integer multiple of the angular spacing between the orientations plus a fraction of that angular spacing.

6. A system according to claim 1 wherein the imaging systems are focussed at respective focal points or planes which are equidistant from the axis of rotation of the object.

7. A system according to claims 1 wherein the imaging systems are focussed at respective focal points or planes which are at different distances from the axis of rotation.

8. A system according to claim 1 wherein each of the imaging systems comprises a respective optical system and image capture means wherein the two image capture means comprise respective parts of an image capture device.

9. A system according to claim 8 wherein at least one of the optical systems includes a fibre optic bundle.

10. A system according to claim 9 wherein the fibre optic bundle comprises a plurality of optic fibres and the relative positions of the fibres in the bundle are different at the two ends of the bundle.

11. A system according to claim 10 wherein the optical system is arranged to change the shape of the image so that area of the image capture means that is arranged to capture the image is a different shape from the area imaged by the imaging system.

12. A system according to claim 11 wherein the optical system is arranged to change the aspect ratio of the image.

13. A system according to claims 10 wherein the processor is arranged to receive image data from the image capture means and process it to generate an image data set, wherein and the processor is arranged to compensate for the change of shape of the image in the optical system.

14. A system according to claim 1 further comprising a sample chamber, wherein the support means is arranged to support the sample within the chamber, and the chamber has a wall part of which is formed by a lens which also forms part of one of the optical systems.

15. A system according to claim 14 wherein each of the optical systems includes a lens which forms part of the wall of the chamber.

16. A system according to claim 14 wherein the chamber is filled with an index matching fluid having a refractive index similar to that of the sample.

17. A system according to claim 14 further comprising a transparent cylinder within the chamber, wherein the chamber is filled with index matching fluid both inside and outside the cylinder, and the cylinder is arranged to rotate inside the chamber, together with the sample.

18. A system according to claim 1 wherein the processor is arranged to identify a feature from the image data set, and then at each of a series of subsequent times, determine the location of that feature from at least two projection images acquired using the optical systems.

19. A system according to claim 18 wherein the processor is arranged to cause rotation of the sample holder during acquisition of the image data set, and to cause acquisition of all of the subsequent projection images with the sample in a constant orientation.
